(19) United States
(12) Patent Application Publication
(10) Pub. No.: US 2024/0188108 A1
(43) Pub. Date: Jun. 6, 2024

(54) SIDELINK CO-CHANNEL CO-EXISTENCE

(71) Applicant: QUALCOMM Incorporated, San Diego, CA (US)

(72) Inventors: Peng CHENG, Beijing (CN); Qing LI, Princeton Junction, NJ (US); Hong CHENG, Basking Ridge, NJ (US); Huilin XU, Temecula, CA (US)

(21) Appl. No.: 18/556,567

(22) PCT Filed: Jul. 2, 2021
(86) PCT No.: PCT/CN2021/104292

§ 371 Date: Oct. 20, 2023

(51) Int. Cl. H04W 72/40; H04W 72/1263; H04W 72/232

(52) U.S. Cl. CPC H04W 72/40; H04W 72/1263; H04W 72/232

(57) ABSTRACT

Aspects of the present disclosure relate to wireless communications, and more particularly, to techniques for configuring sidelink communication. One aspect provides a method for wireless communication by a base station (BS). The method generally includes generating (1110) downlink control information (DCI) for scheduling sidelink (SL) communication for a first radio access technology (RAT), the DCI including a carrier indication field (CIF) indicating a carrier of a second RAT for the SL communication, where the SL communication is between a first user equipment (UE) and a second UE. The BS transmits (1120) the DCI to at least one of the first UE or the second UE.

### INTRODUCTION

Aspects of the present disclosure relate to wireless communications, and more particularly, to techniques for configuring sidelink communication.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a base station (BS). The method generally includes generating downlink control information (DCI) for scheduling sidelink (SL) communication for a first radio access technology (RAT), the DCI including a carrier indication field (CIF) indicating a carrier of a second RAT for the SL communication, wherein the SL communication is between a first user-equipment (UE) and a second UE, and transmitting the DCI to at least one of the first UE or the second UE.

One aspect provides a method for wireless communication by a first UE. The method generally includes receiving DCI for scheduling SL communication for a first RAT, the DCI including a CIF indicating a carrier of a second RAT for the SL communication, wherein the SL communication is between the first UE and a second UE, and communicating with the second UE based on the DCI.

One aspect provides a method for wireless communication by a UE. The method generally includes receiving, from a BS, a configuration for SL traffic splitting between a first protocol stack of the UE and a second protocol stack of the UE, wherein the first protocol stack is for a first RAT and the second protocol stack is for a second RAT, the first RAT being different than the second RAT, and wherein the configuration indicates a layer of the first protocol stack and the second protocol stack to be used for the traffic splitting; and communicating, via the second protocol stack, at least one TB for SL communication in accordance with the configuration.

One aspect provides a method for wireless communication by a base station. The method generally includes generating a message indicating a configuration for SL traffic splitting between a first protocol stack of a UE and a second protocol stack of the UE, wherein the first protocol stack is for a first radio access technology (RAT) and the second protocol stack is for a second RAT, the first RAT being different than the second RAT, and wherein the configuration indicates a layer of the first protocol stack and the second protocol stack to be used for the traffic splitting, and transmitting the message to the UE.

One aspect provides an apparatus for wireless communication by a BS. The apparatus generally includes a memory and one or more processors coupled to the memory, the memory and the one or more processors being configured to generate DCI for scheduling SL communication for a first RAT, the DCI including a CIF indicating a carrier of a second RAT for the SL communication, wherein the SL communication is between a first UE and a second UE, and transmit the DCI to at least one of the first UE or the second UE.

One aspect provides an apparatus for wireless communication by a first UE. The apparatus generally includes a memory and one or more processors coupled to the memory, the memory and the one or more processors being configured to receive DCI for scheduling SL communication for a first RAT, the DCI including a CIF indicating a carrier of a second RAT for the SL communication, wherein the SL communication is between the first UE and a second UE, and communicate with the second UE based on the DCI.

One aspect provides an apparatus for wireless communication by a UE. The apparatus generally includes a memory and one or more processors coupled to the memory, the memory and the one or more processors being configured to receive, from a BS, a configuration for SL traffic splitting between a first protocol stack of the UE and a second protocol stack of the UE, wherein the first protocol stack is for a first RAT and the second protocol stack is for a second RAT, the first RAT being different than the second RAT, and wherein the configuration indicates a layer of the first protocol stack and the second protocol stack to be used for the traffic splitting; and communicate, via the second protocol stack, at least one TB for SL communication in accordance with the configuration.

One aspect provides an apparatus for wireless communication by a BS. The apparatus generally includes a memory and one or more processors coupled to the memory, the memory and the one or more processors being configured to generate a message indicating a configuration for SL traffic splitting between a first protocol stack of a UE and a second protocol stack of the UE, wherein the first protocol stack is for a first RAT and the second protocol stack is for a second RAT, the first RAT being different than the second RAT, and wherein the configuration indicates a layer of the first protocol stack and the second protocol stack to be used for the traffic splitting, and transmit the message to the UE.

One aspect provides an apparatus for wireless communication by a BS. The apparatus generally includes means for generating DCI for scheduling SL communication for a first RAT, the DCI including a CIF indicating a carrier of a second RAT for the SL communication, wherein the SL communication is between a first UE and a second UE, and means for transmitting the DCI to at least one of the first UE or the second UE.

One aspect provides an apparatus for wireless communication by a first UE. The apparatus generally includes means for receiving DCI for scheduling SL communication for a first RAT, the DCI including a CIF indicating a carrier of a second RAT for the SL communication, wherein the SL communication is between the first UE and a second UE, and means for communicating with the second UE based on the DCI.

One aspect provides an apparatus for wireless communication by a UE. The apparatus generally includes means for receiving, from a BS, a configuration for SL traffic splitting between a first protocol stack of the UE and a second protocol stack of the UE, wherein the first protocol stack is for a first RAT and the second protocol stack is for a second RAT, the first RAT being different than the second RAT, and wherein the configuration indicates a layer of the first protocol stack and the second protocol stack to be used for the traffic splitting; and means for communicating, via the second protocol stack, at least one TB for SL communication in accordance with the configuration.

One aspect provides an apparatus for wireless communication by a base station. The apparatus generally includes means for generating a message indicating a configuration for SL traffic splitting between a first protocol stack of a UE and a second protocol stack of the UE, wherein the first protocol stack is for a first RAT and the second protocol stack is for a second RAT, the first RAT being different than the second RAT, and wherein the configuration indicates a layer of the first protocol stack and the second protocol stack to be used for the traffic splitting, and means for transmitting the message to the UE.

A non-transitory computer-readable medium comprising executable instructions that, when executed by one or more processors of a BS, cause the BS to generate DCI for scheduling SL communication for a first radio access technology (RAT), the DCI including a CIF indicating a carrier of a second RAT for the SL communication, wherein the SL communication is between a first UE and a second UE, and transmit the DCI to at least one of the first UE or the second UE.

A non-transitory computer-readable medium comprising executable instructions that, when executed by one or more processors of a first UE, cause the first UE to receive DCI for scheduling SL communication for a first RAT, the DCI including a CIF indicating a carrier of a second RAT for the SL communication, wherein the SL communication is between the first UE and a second UE, and communicate with the second UE based on the DCI.

A non-transitory computer-readable medium comprising executable instructions that, when executed by one or more processors of a UE, cause the UE to receive, from a BS, a configuration for SL traffic splitting between a first protocol stack of the UE and a second protocol stack of the UE, wherein the first protocol stack is for a first RAT and the second protocol stack is for a second RAT, the first RAT being different than the second RAT, and wherein the configuration indicates a layer of the first protocol stack and the second protocol stack to be used for the traffic splitting; and communicate, via the second protocol stack, at least one TB for SL communication in accordance with the configuration.

A non-transitory computer-readable medium comprising executable instructions that, when executed by one or more processors of a BS, cause the BS to generate a message indicating a configuration for SL traffic splitting between a first protocol stack of a UE and a second protocol stack of the UE, wherein the first protocol stack is for a first RAT and the second protocol stack is for a second RAT, the first RAT being different than the second RAT, and wherein the configuration indicates a layer of the first protocol stack and the second protocol stack to be used for the traffic splitting, and transmit the message to the UE.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station and user equipment.

FIGS. 3A-3D depict various example aspects of data structures for a wireless communication network.

FIGS. 3E-3F depict various example sidelink communication systems.

FIG. 4 illustrates a diagram showing examples for implementing a communications protocol stack in a radio access network (RAN), in accordance with certain aspects of the present disclosure.

FIGS. 5A-5B are block diagrams that illustrate techniques for implementing carrier aggregation (CA) in multiple layers of a protocol stack, in accordance with certain aspects of the present disclosure.

FIGS. 6 and 7 are block diagrams illustrating techniques for implementing CA with co-existence across radio access technologies (RATs), in accordance with certain aspects of the present disclosure.

FIG. 8 is a call flow diagram illustrating example operations for carrier selection, in accordance with certain aspects of the present disclosure.

FIGS. 9 and 10 illustrate example techniques for indicating carrier selection for sidelink transmissions via a carrier indication field (CIF), in accordance with certain aspects of the present disclosure.

FIG. 11 is a flow diagram illustrating example operations for wireless communication by a BS, in accordance with certain aspects of the present disclosure.

FIG. 12 is a flow diagram illustrating example operations for wireless communication by a user equipment (UE), in accordance with certain aspects of the present disclosure.

FIG. 13 is a call flow diagram illustrating example operations for configuring traffic splitting for sidelink communication, in accordance with certain aspects of the present disclosure.

FIGS. 14-16 illustrate example techniques for traffic splitting for sidelink (SL) communication, in accordance with certain aspects of the present disclosure.

FIG. 17 is a flow diagram illustrating example operations for wireless communication by a UE, in accordance with certain aspects of the present disclosure.

FIG. 18 is a flow diagram illustrating example operations for wireless communication by a BS, in accordance with certain aspects of the present disclosure.

FIG. 19 is a call flow diagram illustrating example operations for carrier selection and configuring traffic splitting for sidelink communication, in accordance with certain aspects of the present disclosure.

FIGS. 20 and 21 depict aspects of example communications devices.

### DETAILED DESCRIPTION

Aspects of the present disclosure provide apparatuses, methods, processing systems, and computer-readable mediums for a first radio access technology (RAT) (e.g., new radio (NR)) to use the spectrum of a second RAT (e.g., long term evolution (LTE)) for SL communication. For example, NR applications or services (e.g., vehicle-to-everything (V2X), or any SL communication between two UEs) may use wide band operations to meet lower latency and higher data rate specifications. However, in certain scenarios, a rather limited spectrum may be assigned for such operations. For example, a 10 MHz bandwidth (BW) may be available for NR V2X. Therefore, one or more aspects of the present disclosure provide techniques to facilitate sharing of resources (e.g., carriers) across RATs (e.g., sharing of LTE resources with NR) to provide resources for a RAT (e.g., NR) having a limited spectrum available for communication.

Certain aspects of the present disclosure provide techniques for using an unoccupied carrier within the LTE band to transmit NR packets on SL. For example, a base station (BS) may indicate to a user equipment (UE), via downlink control information (DCI), an LTE carrier that may be unoccupied and may be used for transmitting an NR packet on SL to another UE. As one example, the BS may transmit a DCI having a carrier indication field (CIF). The CIF may indicate the unoccupied carrier to be used for transmitting the NR packet on SL. Some aspects of the present disclosure further provide traffic splitting techniques at the UE to facilitate the NR packet transmission using the LTE carrier. Traffic splitting generally refers to a transfer of a packet from one protocol stack (e.g., a protocol stack for NR) to another protocol stack (e.g., a protocol stack for LTE). Traffic splitting may occur at different layers of protocol stacks at the UE, per a configuration indicated to the UE by the BS. As one example, traffic splitting may be implemented at a medium access control (MAC) layer. That is, a packet generated at an NR protocol stack of the UE may be sent to the LTE protocol stack of the UE through the MAC layer, as indicated by the BS.

The aspects of the present disclosure provide techniques for using of an unoccupied carrier of one RAT (e.g., LTE) for communication of sidelink packets for another RAT (e.g., NR). The aspects described serve to increase resource utilization by allowing the unoccupied carrier of one RAT to be used by another RAT, resulting in lowering latency for the other RAT, and assisting the other RAT to meet high data rate specifications.

### Introduction to Wireless Communication Networks

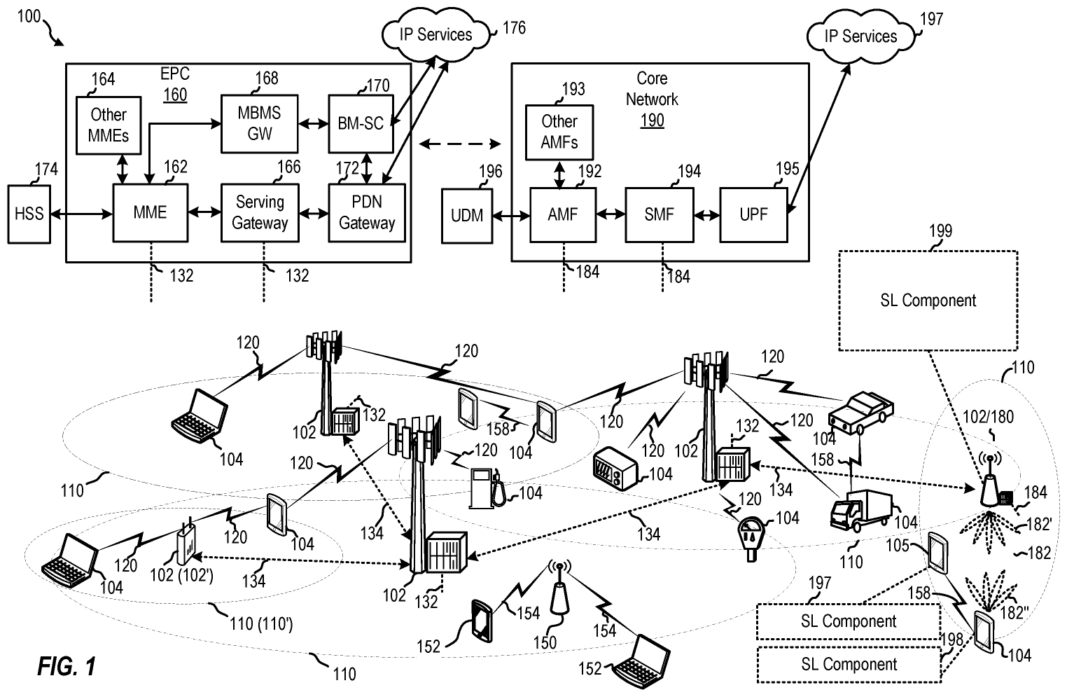

FIG. 1 depicts an example of a wireless communications system 100, in which aspects described herein may be implemented.

Generally, wireless communications system 100 includes base stations (BSs) 102 (which may also be referred to herein as access node (AN) 102), user equipments (UEs) 104, an Evolved Packet Core (EPC) 160, and core network 190 (e.g., a 5G Core (5GC)), which interoperate to provide wireless communications services.

Base stations 102 may provide an access point to the EPC 160 and/or core network 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, Node B, eNB, an access point, a base transceiver station, a radio base station, a radio transceiver, or a transceiver function, or a transmit reception point (TRP) in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Wireless communication network 100 includes a SL component 199, which may configure a UE (e.g., UE 104 and/or UE 105) to use an unoccupied carrier of one RAT (e.g., LTE) to transmit or receive a packet for another RAT (e.g., NR) on SL. For instance, the BS 102 may transmit downlink control information (DCI) including a carrier indication field (CIF) indicating a carrier of LTE to be used for SL communication for NR. In some aspects, the transmission of the packet by the UE 104 for NR on the unoccupied carrier of LTE may be implemented using traffic splitting on a layer of a protocol stack of the UE 104. The layer of the protocol stack to be used for the traffic splitting may be indicated by the BS 102. Wireless network 100 further includes a SL component 198, which may be used to configure the UE 104 to use the unoccupied carrier of one RAT to transmit a packet for another RAT on SL. Wireless network 100 further includes a SL component 197, which may be used to configure the UE 105 to use the unoccupied carrier of one RAT to receive a packet for another RAT on SL. For instance, the UE 104 and UE 105 may receive DCI including a CIF indicating a carrier of LTE to be used for SL communication for NR. In some aspects, the transmission of the packet for NR on the unoccupied carrier of LTE may be implemented using traffic splitting on a layer of a protocol stack of the UE 104 as indicated by the BS 102.

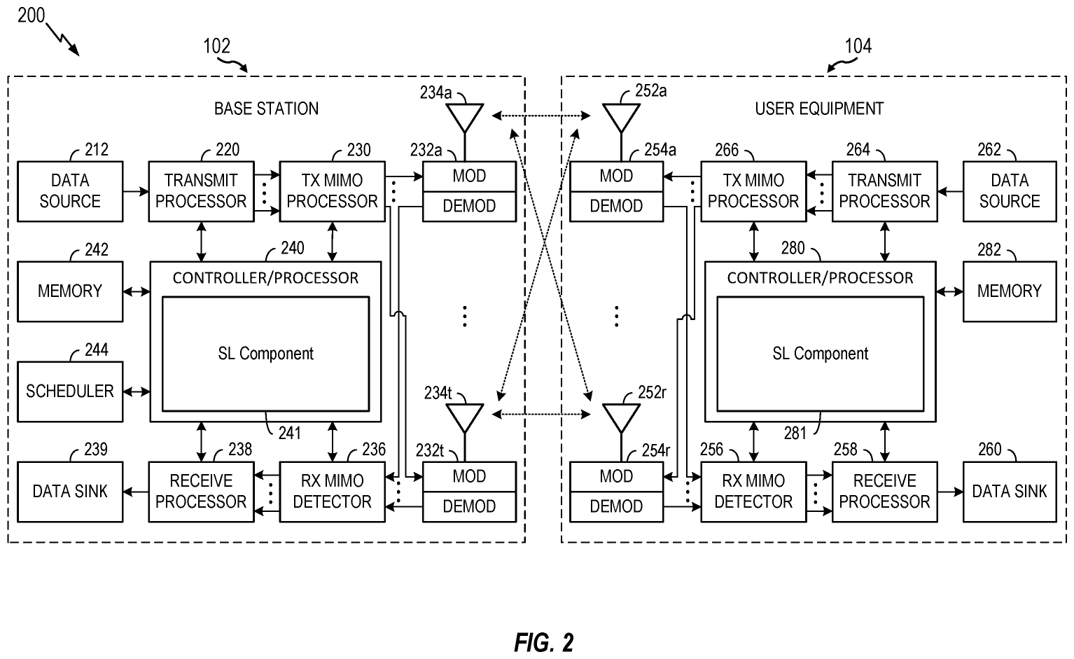

FIG. 2 depicts aspects of an example base station (BS) 102 and a user equipment (UE) 104.

Generally, base station 102 includes various processors (e.g., 220, 230, 238, and 240), antennas 234a-t (collectively antennas 234), transceivers 232a-t (collectively transceivers 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes a SL component 241, which may be representative of SL component 199 of FIG. 1. Notably, while depicted as an aspect of controller/processor 240, a SL component 241 may be implemented additionally or alternatively in various other aspects of base station 102 in other implementations.

Generally, user equipment 104 includes various processors (e.g., 258, 264, 266, and 280), antennas 252a-r (collectively antennas 252), transceivers 254a-r (collectively transceivers 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes SL component 281, which may be representative of SL component 197 or 198 of FIG. 1. Notably, while depicted as an aspect of controller/processor 280, SL component 281 may be implemented additionally or alternatively in various other aspects of user equipment 104 in other implementations.

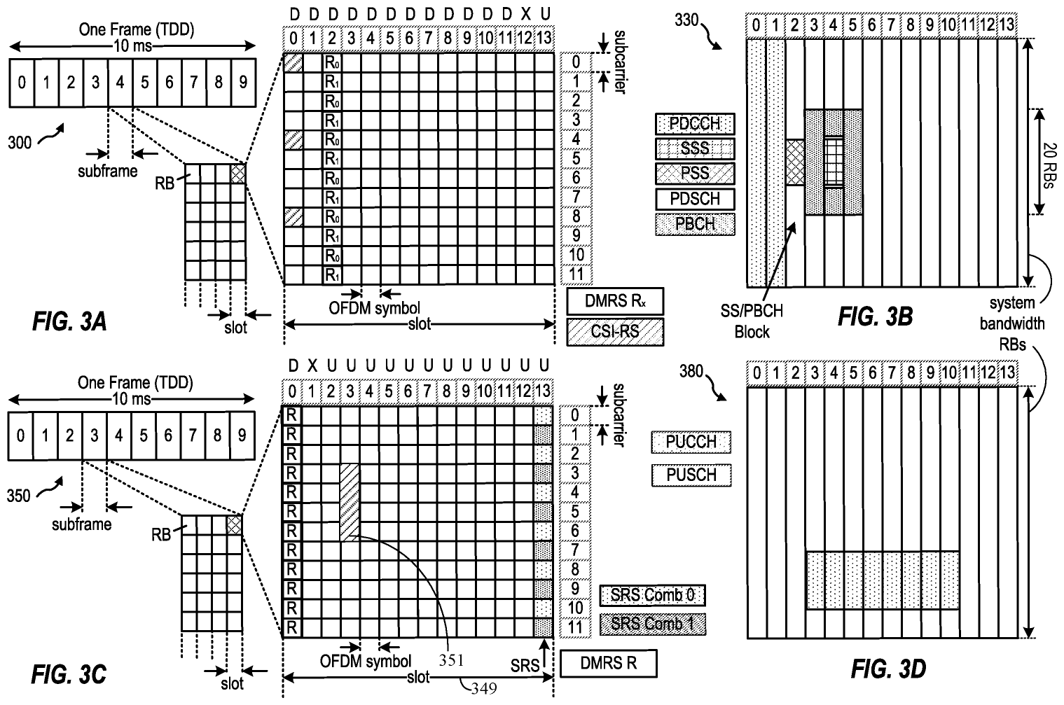

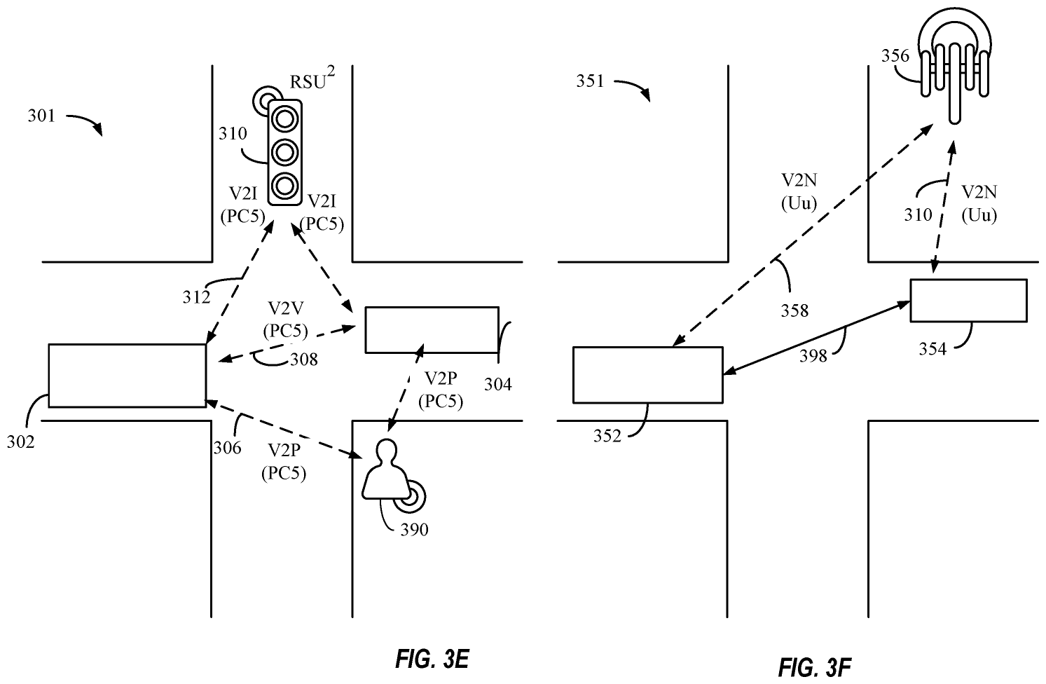

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe. In some aspects, UEs may be configured to communicate (e.g., SL communications) using the frame format described with respect to diagrams 300, 330, 350, 380. For example, as shown in FIG. 3C, a portion of slot 349 may be used for SL communication 351. The SL communication 351 may be used to communicate sidelink control information (SCI) from one UE to another UE. A radio frame (e.g., as shown in diagram 300) may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS, during which SL communication may occur. Further discussions regarding FIG. 1, FIG. 2, and FIGS. 3A-3D are provided later in this disclosure.

### Introduction to Sidelink

FIGS. 3E and 3F show diagrammatic representations of example vehicle to everything (V2X) systems in accordance with some aspects of the present disclosure. For example, the UEs shown in FIGS. 3E and 3F may communicate via sidelink channels and may perform sidelink CSI reporting as described herein.

The V2X systems, provided in FIGS. 3E and 3F provide two sidelink operating modes. A first sidelink operating mode, shown by way of example in FIG. 3E, involves direct communications (for example, also referred to as side link communications) between participants in proximity to one another in a local area. The first sidelink operating mode may be referred to as NR mode 2 when using NR technology, or may be referred to as LTE mode 4 when using LTE technology. In NR mode 2 or LTE mode 4, a UE may autonomously configure resources for SL communication (e.g., without management by a BS). A second sidelink operating mode, shown by way of example in FIG. 3F, involves communications through a network, which may be implemented over a Uu interface (for example, a wireless communication interface between a radio access network (RAN) and a UE). As illustrated, UEs 352, 354 may communicate with each other using a sidelink (SL) 398. The second sidelink operating mode may be referred to as NR mode 1 when using NR technology, or may be referred to as LTE mode 3 when using LTE technology. In NR mode 1 and LTE mode 3, the SL communication of a UE (e.g., UE 352 or UE 354) may be managed (e.g., scheduled) by a BS (e.g., network entity 356).

Referring to FIG. 3E, a V2X system 301 (for example, including vehicle to vehicle (V2V) communications) is illustrated with two UEs 302, 304 (e.g., vehicles). The first transmission mode allows for direct communication between different participants in a given geographic location. As illustrated, a vehicle can have a wireless communication link 306 with an individual 390 (V2P) (for example, via a UE) through an interface such as a PC5 interface. Communications between the UEs 302 and 304 may also occur through an interface 308 (e.g., a PC5 interface). In a like manner, communication may occur from a UE 302 to other highway components (for example, highway component 310), such as a traffic signal or sign (V2I) through an interface 312 (e.g., PC5 interface). With respect to each communication link illustrated in FIG. 3E, two-way communication may take place between wireless nodes, therefore each wireless node may be a transmitter and a receiver of information. The V2X system 301 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 3F shows a V2X system 351 for communication between a UE 352 (e.g., vehicle) and a UE 354 (e.g., vehicle) through a network entity 356. These network communications may occur through discrete nodes, such as a base station (for example, an eNB or gNB), that sends and receives information to and from (for example, relays information between) UEs 352, 354. The network communications through vehicle to network (V2N) links (e.g., Uu links 358 and 310) may be used, for example, for long range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. Other applications of sidelink communications may include public safety or service announcement communications, communications for proximity services, communications for UE-to-network relaying, device-to-device (D2D) communications, Internet of Everything (IoE) communications, Internet of Things (IoT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes in some scenarios. In some examples, a sidelink signal may be communicated using a licensed spectrum (unlike wireless local area networks, which typically use an unlicensed spectrum). While FIGS. 3E and 3F describe techniques for sidelink communication by referring to vehicles, the aspects described herein are applicable to any UEs capable of sidelink communication.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as channel state information (CSI) related to a sidelink channel quality.

### Example Protocol Stack

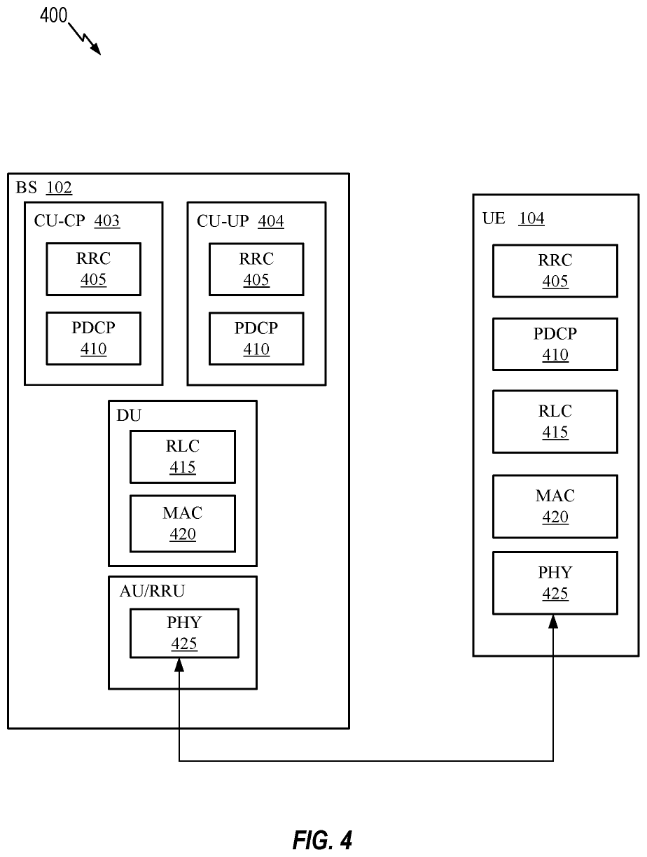

FIG. 4 is a diagram showing examples for implementing a communications protocol stack 400 in a radio access network (RAN), according to aspects of the present disclosure. The illustrated communications protocol stack 400 may be implemented by devices operating in a wireless communication system, such as a 5G NR system (e.g., the wireless communication network 100 of FIG. 1). In various examples, the layers of the protocol stack 400 may be implemented as separate modules of software, portions of a processor or application-specific integrated circuit (ASIC), portions of non-collocated devices connected by a communications link, or various combinations thereof. Collocated and non-collocated implementations may be used, for example, in a protocol stack for a network access device or a UE. As shown in FIG. 4, the system may support various services over one or more protocols. One or more protocol layers of the protocol stack 400 may be implemented by the BS 102 and/or a UE 104.

As shown in FIG. 4, the protocol stack 400 is split in the BS 102. The radio resource control (RRC) layer 405, packet data convergence protocol (PDCP) layer 410, radio link control (RLC) layer 415, media access control (MAC) layer 420, and physical (PHY) layer 425 may be implemented by the BS 102.

An RRC layer controls various RRC protocol functions such as control of RRC connection, control of handover, measurement reporting, etc. The RLC layer is responsible for transfer of upper layer protocol data units, error correction, concatenation, segmentation and reassembly of RLC service data units (SDUs). The MAC layer performs scheduling of data on carriers. The PHY layer provides a means for transmitting of bits over a physical data link on the carriers.

A central unit-control plane (CU-CP) 403 and a central unit-user plane (CU-UP) 404 each may implement the RRC layer 405 and the PDCP layer 410. A distributed unit (DU) may implement the RLC layer 415 and MAC layer 420. The Antenna/Remote Radio Units (AU/RRU) may implement the PHY layer(s) 425. The PHY layers 425 may include a high PHY layer and a low PHY layer. The UE 104 may implement the entire protocol stack 400 (e.g., the RRC layer 405, the PDCP layer 410, the RLC layer 415, the MAC layer 420, and the PHY layer(s) 425). As shown, the PHY layers 430 of the BS 102 and UE 102 may facilitate wireless communication between the BS 102 and UE 104.

### Introduction on Carrier Aggregation on Sidelink

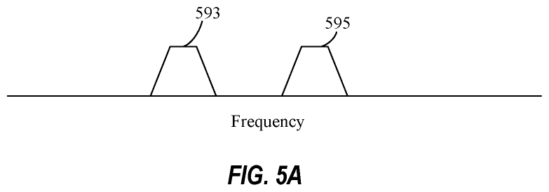

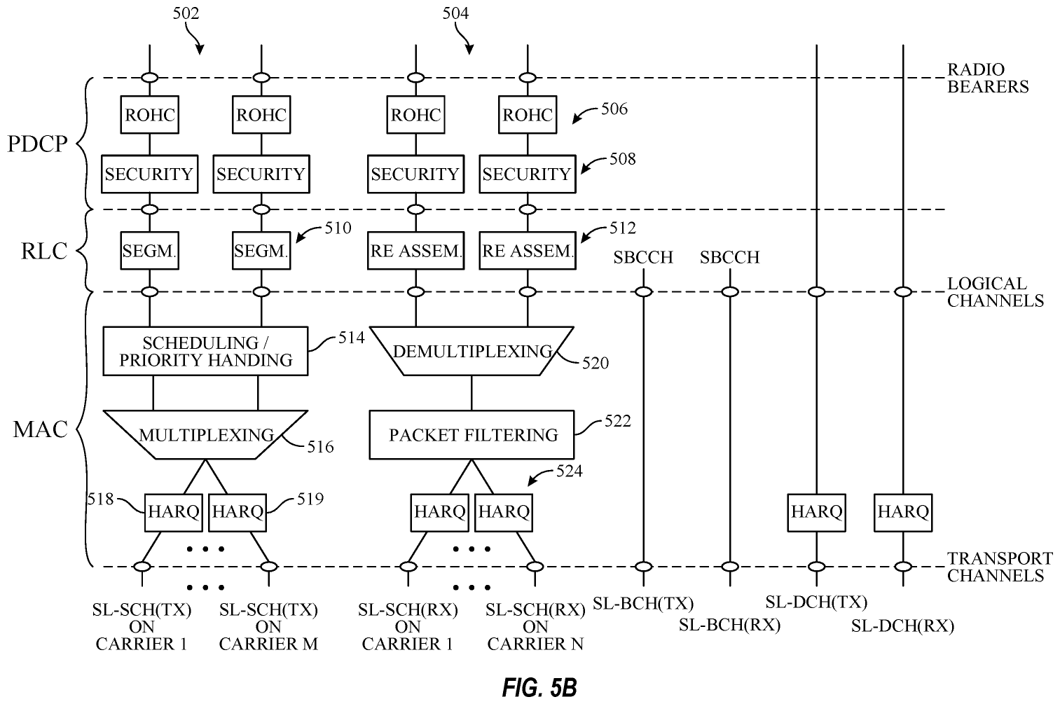

FIG. 5A is a diagram illustrating carrier aggregation (CA). Carrier aggregation is a technique used in wireless communication to increase the data rate per user, whereby multiple frequency blocks (also referred to as component carriers) are assigned to the same UE. For example, carrier 593 and carrier 595 may be assigned to the UE and the UE may transmit signaling using both carrier 593 and carrier 595. While two carriers are shown in FIG. 5A to facilitate understanding, any number of carriers may be used, such as carrier 1 to carrier M, M being an integer greater than 1.

FIG. 5B is a block diagram that illustrates techniques for implementing CA. As shown, a packet data convergence protocol (PDCP) layer (e.g., corresponding to the PDCP layer 410 of FIG. 4) for a protocol stack 502 (e.g., for transmission) may include robust header compression (ROHC) components 506 and security components 508. An ROHC component perform compression of packets. The ROHC components 506 perform packet compression for radio bearers. Radio bearers are channels used for the transfer of either user or control data. The security component 508 performs various security functions such as integrity protection and ciphering.

As illustrated, a radio link control (RLC) layer (e.g., corresponding to the RLC layer 415 of FIG. 4) of the protocol stack 502 may include segmentation components 510 (e.g., segmenting a packet into multiple service data units (SDUs) based on the information carried by an RLC header). Further, a media access control (MAC) layer (e.g., corresponding to the MAC layer 420 of FIG. 4) of the protocol stack 502 may include a schedule/priority handling component 514, a multiplexer 516, and hybrid automatic repeat request (HARQ) components 518, 519. The schedule/priority handling component 514 may perform scheduling of logical channels to carriers. After performing the scheduling, the multiplexer 516 provides packets to HARQ components for the scheduled carriers. In other words, a protocol stack may include a HARQ component for each carrier configured for signal transmission (e.g., M carriers, where M is a positive integer). The scheduling/priority handling component 514 may schedule packets for transmission on the carriers. For example, the scheduling/priority handling component 514 may generate a RLC protocol data unit (PDU), which may be provided to the multiplexer 516 for generating a MAC PDU. HARQ components 518, 519 may generate transport blocks (TBs) based on the MAC PDU for transmission on the carriers. For example, multiple HARQ components (e.g., HARQ components 518, 519) may be used to implement CA on carriers (e.g., carriers 1 to carrier M, as shown in FIG. 5B) to transmit TBs. That is, multiple TBs may be transmitted on different carriers to increase throughput gain. A TB generally refers to a payload passed between the MAC and PHY layers. There may be one independent HARQ component per carrier used for V2X SL communication and each TB and its potential HARQ retransmissions may be mapped to a single carrier, in some implementations.

As illustrated, a protocol stack 504 may be implemented for reception which may include a MAC layer having HARQ components 524, a packet filtering component 522, and a demultiplexing component 520 used to process received TBs. The protocol stack 504 may include a HARQ component 524 for each carrier (e.g., N carriers, where N is a positive integer). As shown, the protocol stack 504 may include an RLC layer having reassembly components 512 and a PDCP layer having security components 508 and ROHC components 506.

In some cases, SL CA with resource allocation may be implemented with a BS transmitting downlink control information (DCI) having a carrier indication field (CIF) to indicate a carrier to be used for SL. In some implementations, SL CA may use a sensing procedure to select resources independently on each involved carrier. The same carrier may be used for all TBs of the same SL process at least until another resource re-selection is triggered.

Communication on sidelink (SL) may be implemented using dual-connectivity (DC) with multiple radio access technologies (RATs) (e.g., NR and LTE). Some aspects of the present disclosure allow for sidelink (SL) communication for a RAT (e.g., new radio (NR)) to dynamically and opportunistically use the spectrum allocated for another RAT (e.g., long term evolution (LTE)). For instance, a first transmission-reception point (TRP) associated with a first RAT may indicate to a second TRP associated with a second RAT that one or more carriers of the first RAT are unoccupied, allowing the second TRP to configure UEs to use the one or more carriers for communication on SL. While some examples are described herein with respect to LTE and NR to facilitate understanding, the aspects of the present disclosure may be implemented for any suitable RATs.

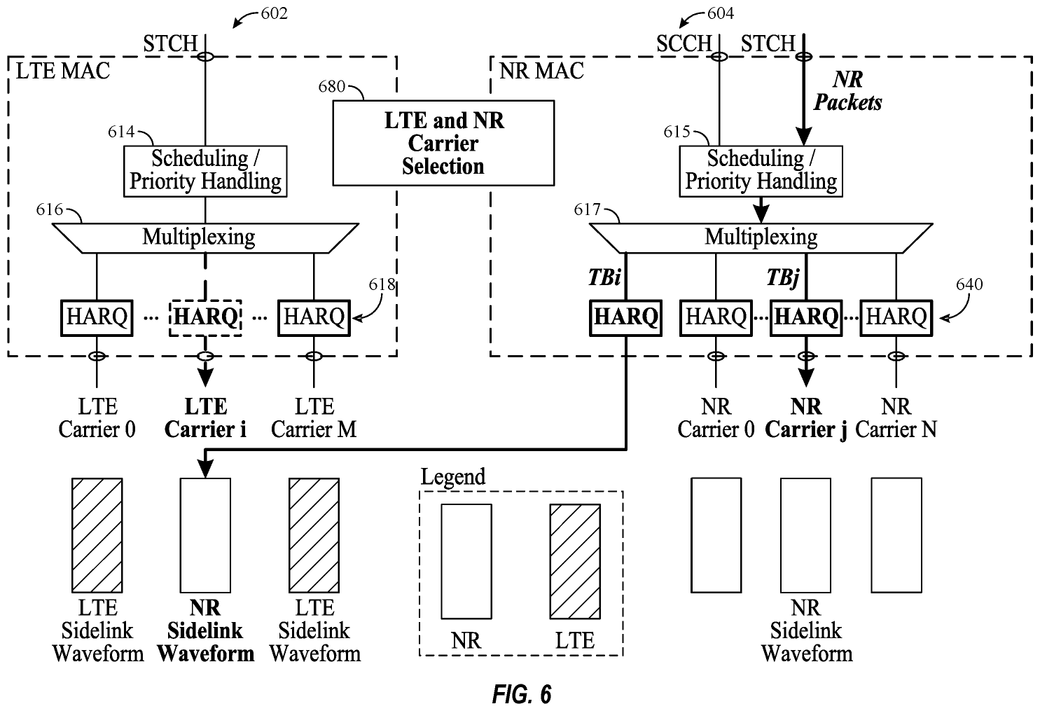

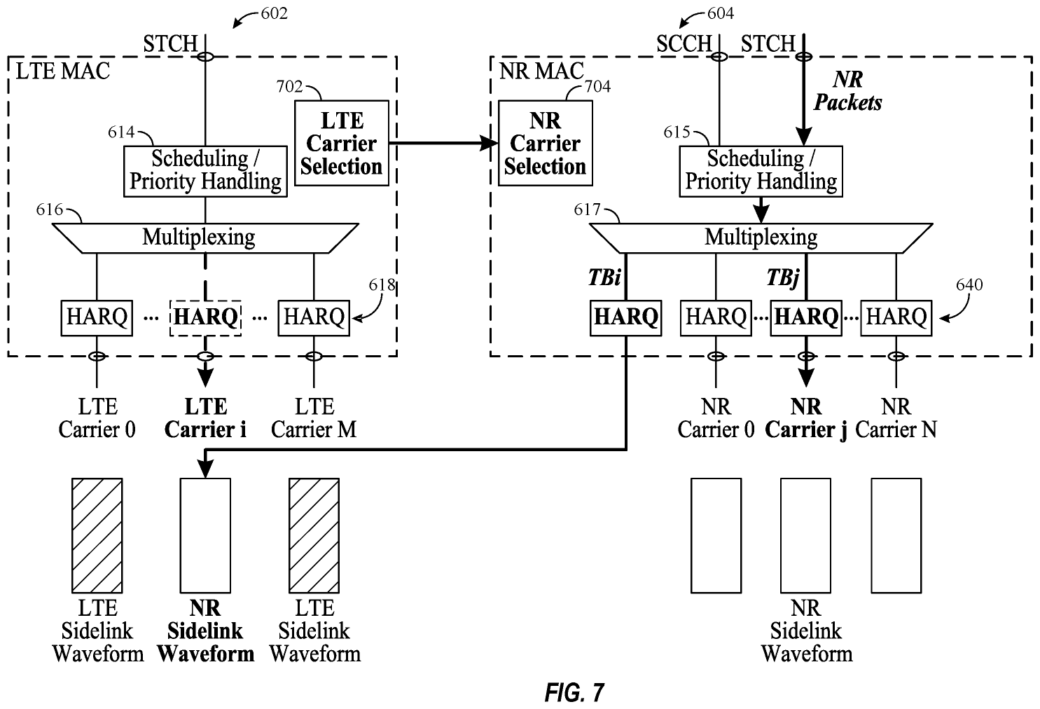

FIGS. 6 and 7 are block diagrams illustrating techniques for implementing co-existence between RATs (e.g., NR and LTE according to one example). The components shown in FIGS. 6 and 7 may be implemented in a UE. As illustrated, a protocol stack 602 may be implemented for LTE and may include a scheduling/priority handling component 614 (e.g., corresponding to the scheduling/priority handling component 514 of FIG. 5B), a multiplexer 616 (e.g., corresponding to the multiplexer 516 of FIG. 5B), as well as HARQ components 618 (e.g., corresponding to HARQ components 518, 519 of FIG. 5B). As illustrated, another protocol stack 604 may be implemented for NR which may include a scheduling/priority handling component 615 (e.g., corresponding to the scheduling/priority handling component 514 of FIG. 5B), a multiplexer 617 (e.g., corresponding to the multiplexer 516 of FIG. 5B), as well as HARQ components 640 (e.g., corresponding to HARQ components 518, 519 of FIG. 5B). The scheduling/priority handling component 615 may be configured to receive signaling for a sidelink control channel (SCCH) and a sidelink traffic channel (STCH).

As shown in FIGS. 6 and 7, NR packets (e.g., TBᵢ) carried on a NR physical signal and channels may be transmitted over LTE's unoccupied carrier (e.g., LTE Carrier i). Different approaches may be taken to determine the unoccupied carrier of LTE that may be used. For example, as illustrated in FIG. 6, a carrier selection component 680 (e.g., for an NR protocol stack) may be used to select LTE and NR carriers based on measurements of parameters such as a constant bit rate (CBR), reference signal received power (RSRP), or received signal strength indicator (RSSI) over the configured carriers. The carrier selection component 680 may then control the scheduling of transmissions for SL (e.g., via the scheduling/priority handling component 615).

In other cases, as illustrated in FIG. 7, an LTE carrier selection component 702 of the LTE protocol stack MAC layer may select an unoccupied carrier to be used by NR and indicate the carrier to a NR carrier selection component 704 of the NR protocol stack MAC layer. In each of the examples of FIGS. 6 and 7, the HARQ for a TB (e.g., TBᵢ) for SL transmission on LTE carrier i may be handled by the NR SL MAC layer, as shown. In some cases, NR logical channel prioritization (LCP) restrictions may be enhanced for special handling for NR SL transmissions in LTE carriers. For example, only STCH with lower priority may be multiplexed in TBi transmitted over the LTE carrier.

It may be assumed that LTE and NR SL(s) each have a list of carriers (in different bands), and each supports SL CA. Accordingly, a first RAT (e.g., NR) may use the spectrum of SL for a second RAT (e.g., LTE), increasing resource utilization. For example, with the coordination of carrier selection between LTE and NR SL, NR SL may be allowed to use unoccupied LTE SL carriers dynamically, increasing resource utilization by facilitating usage of the otherwise unoccupied LTE SL carrier for NR SL.

NR and LTE may be implemented using different modes of operation, referred to as NR mode 1, NR mode 2, LTE mode 3, and LTE mode 4. In NR mode 1 or LTE mode 3, the SL communication of the UE may be managed (e.g., scheduled) by a BS, whereas in NR mode 2 or LTE mode 4, the UE may automatically configure resources for SL communication. In some aspects, for NR mode 1, a BS (e.g., a gNB) may schedule SL transmission with a NR waveform via a carrier indication field (CIF) in DCI having a particular format (e.g., DCI-format 3-0). In another aspect, for NR mode 1, a BS (e.g., a gNB) may schedule SL transmission with an LTE waveform via a CIF in DCI having a particular format (e.g., DCI-format 3-1). As used herein, a waveform for a particular RAT generally refers to the waveform configured (e.g., standardized) for the RAT. For example, an LTE wave form may include orthogonal frequency-division multiple access (OFDMA) or single-carrier (SC)-frequency-division multiple access (FDMA), and an NR waveform may include cyclic prefix (CP)-orthogonal frequency-division multiplexing (OFDM) or direct Fourier transform spread OFDM (DFT-s-OFDM). A carrier for a particular RAT (e.g., an LTE carrier or NR carrier) generally refers to a frequency band allocated for communication by devices using that RAT.

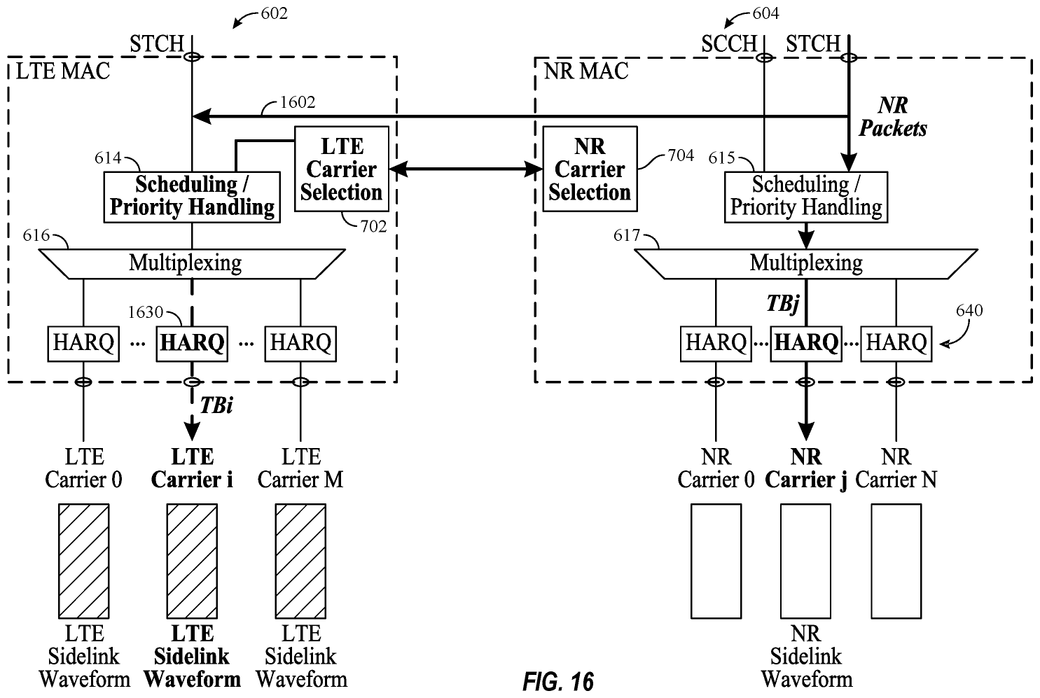

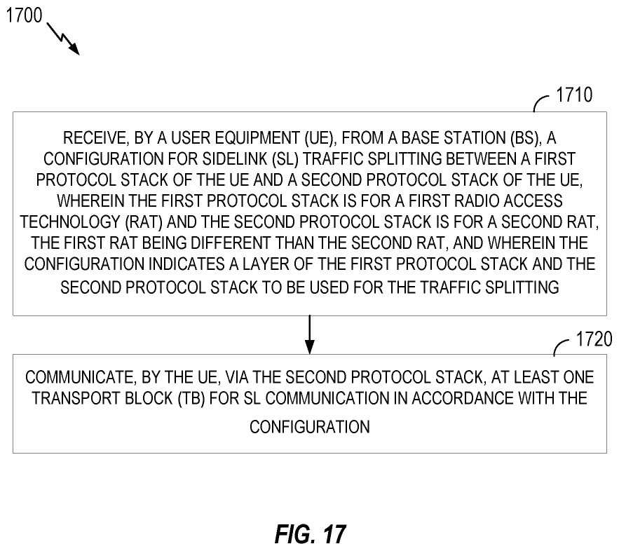

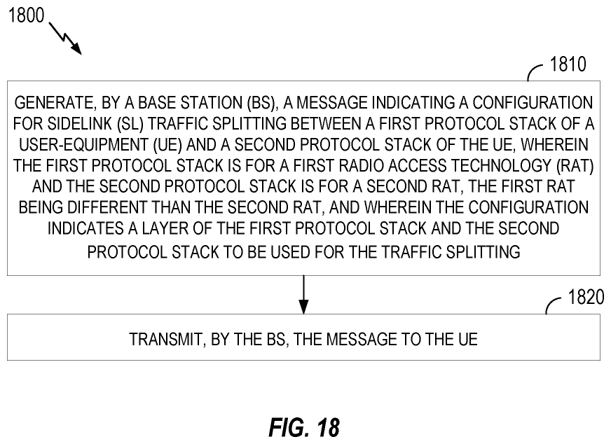

In some aspects, for NR mode 2, a UE may transmit with an NR SL waveform via traffic splitting in a PDCP layer, as described in more detail with respect to FIG. 16. In some aspects of the present disclosure, for NR mode 2, a UE may transmit with an LTE SL waveform via traffic splitting in a lower MAC layer, as will be described in more detail herein with respect to FIGS. 17-18.

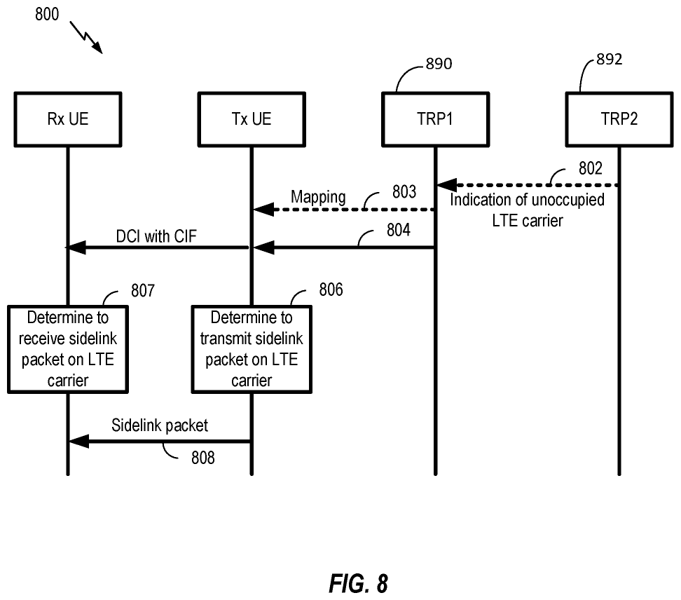

FIG. 8 is a call flow diagram illustrating example operations 800 for configuring SL communication, in accordance with certain aspects of the present disclosure. TRP1 (e.g., an NR BS) (e.g., TRP 890) may be implemented for a first RAT (e.g., a NR) and TRP2 (e.g., an LTE BS) (e.g,. TRP 892) may be implemented for a second RAT (e.g., LTE). The operations 800 depicted in the call flow may be used to indicate to a receive (Rx) UE and a transmit (Tx) UE that one or more carriers are available in LTE to communicate a NR SL message/packet on a LTE carrier. A Tx UE generally refers to a UE that is transmitting during a SL communication occasion, and a Rx UE generally refers to a UE that is receiving during the SL communication occasion.

As shown, TRP2 may optionally provide, to TRP1, an indication 802 of at least one unoccupied LTE carrier. TRP1 may indicate DCI 804 to each of the Rx UE and Tx UE, where the DCI indicates a CIF. The CIF may indicate the at least one unoccupied LTE carrier to be used for SL communication between the Rx UE and the Tx UE. In some aspects, a mapping 803 may indicate the mapping between the CIF and the LTE carrier. For example, the mapping 803 may indicate a mapping between candidate CIFs (e.g., CIF 1 and CIF 2) and candidate carriers (e.g., carrier 1 and carrier 2). At block 806, the Tx UE determines to transmit a SL packet on the unoccupied LTE carrier, and at block 807, the Rx UE determines to receive the SL packet on the unoccupied LTE carrier. The Tx UE then transmits the SL packet 808 to the Rx UE.

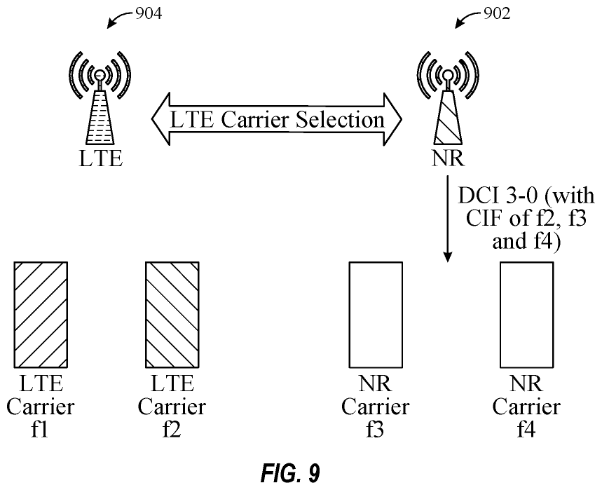

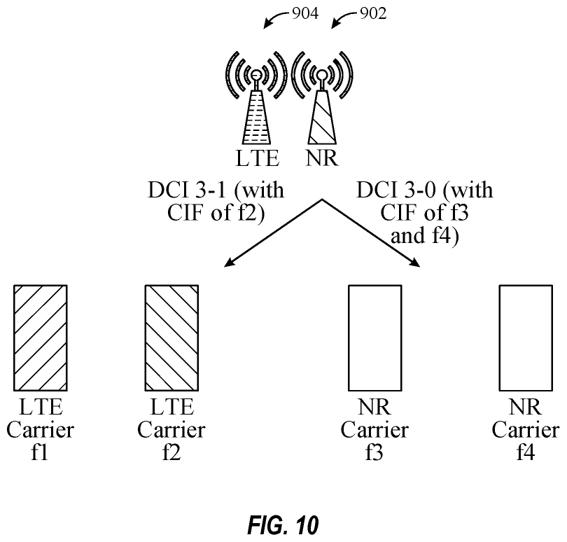

FIGS. 9 and 10 illustrate scheduling of SL transmissions via a CIF for NR mode 1, in accordance with certain aspects of the present disclosure. As shown, a NR TRP 102 may transmit a DCI (e.g., DCI format 3-0) to schedule a SL transmission for NR, the SL transmission using an NR waveform. The DCI may include a CIF indicating an unoccupied LTE carrier (e.g., carrier f2). In other words, the particular format (e.g., DCI format 3-0) may be configured to schedule a SL transmission that uses the NR waveform.

In certain aspects, a mapping of carriers to CIF may be configured via RRC signaling (e.g., RRC message). Accordingly, the NR DCI (e.g., DCI format 3-0) may schedule the NR SL transmission in the unoccupied LTE carrier f2 by indicating the CIF mapped to LTE carrier f2. In certain aspects, each LTE and NR carrier may be mapped to a CIF that may be indicated in the DCI. As shown, an LTE TRP 904 may indicate an LTE carrier selection outcome to the NR TRP 902 so that the NR TRP 902 can configure an unoccupied LTE carrier for SL transmission via the DCI. Thus, the LTE carrier selection may facilitate the transmission of NR SL message(s) on the LTE carrier.

In some cases, LTE SL communications may operate in LTE mode 3 or LTE mode 4. In the case of LTE mode 4, the UE may perform LTE carrier selection. The LTE may report, via a sidelink UE information parameter, the LTE carrier selection outcome and/or measurements to the BS, allowing the BS to use the LTE carrier selection or measurements for performing carrier selection for other UEs. In some aspects, the LTE TRP and the NR TRP may be co-located (e.g., part of the same BS or facility). In other aspects, the LTE TRP may indicate information regarding LTE carrier selection via X2 signaling (e.g., when the LTE TRP and NR TRP are not co-located).

As shown in FIG. 10, the LTE TRP and the NR TRP may be co-located in a BS. The NR TRP may transmit a DCI (e.g., format 3-1 DCI) configuring an NR scheduled SL transmission. The DCI may have a CIF indicating an unoccupied LTE carrier. As illustrated, a CIF (e.g., corresponding to LTE carrier f2) may be included in the DCI for the NR scheduled SL transmission. The SL transmission scheduled using DCI format 3-1 may use an LTE waveform. Similar to the implementation in FIG. 9, the mapping of carriers to CIF may be configured in RRC signaling. As shown, the NR DCI may schedule the NR SL transmission in unoccupied LTE carrier f2. A separate LTE carrier list may be configured and mapped to CIF to be included in DCI having DCI format 3-1. The aspects described with respect to FIG. 10 may be implemented with the UE operating in LTE mode 3 or LTE mode 4. In case of LTE mode 4, the UE may report the LTE carrier selection outcome to the BS via sidelink UE information, as described herein.

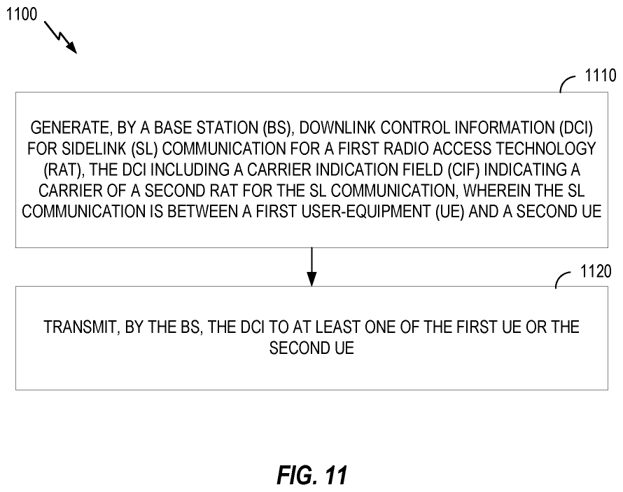

FIG. 11 is a flow diagram illustrating example operations 1100 for wireless communication, in accordance with certain aspects of the present disclosure. The operations 1100 may be performed, for example, by a network entity and/or a BS (e.g., the BS 110a in the wireless communication network 100). The operations 1100 may be implemented as software components that are executed and run on one or more processors (e.g., controller/processor 240 of FIG. 2). Further, the transmission and reception of signals by the BS in operations 1100 may be enabled, for example, by one or more antennas (e.g., antennas 234 of FIG. 2). In certain aspects, the BS's transmission and/or reception of signals may be implemented via a bus interface of one or more processors (e.g., controller/processor 240) obtaining and/or outputting signals.

The operations 1100 begin, at block 1110, by generating DCI (e.g., DCI 804) for SL communication for a first RAT (e.g., NR), the DCI including a CIF indicating a carrier of a second RAT (e.g., LTE) for the SL communication, where the SL communication is between a first UE (e.g., Tx UE) and a second UE (e.g., Rx UE). At block 1120, the BS transmits the DCI to at least one of the first UE or the second UE. In some aspects, the first RAT may be associated with a first waveform, the second RAT may be associated with a second waveform that is different than the first waveform. In some aspects, the DCI schedules the SL communication using the first waveform associated with the first RAT. In other aspects, the DCI schedules the SL communication using the second waveform associated with the second RAT.

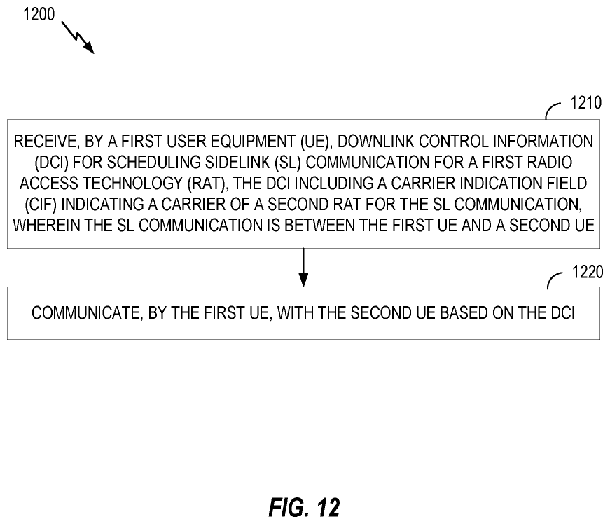

FIG. 12 is a flow diagram illustrating example operations 1200 for wireless communication, in accordance with certain aspects of the present disclosure. The operations 1200 may be performed, for example, by a first UE (e.g., the UE 120a in the wireless communication network 100). The operations 1200 may be complementary to the operations 1200 performed by the BS. The operations 1200 may be implemented as software components that are executed and run on one or more processors (e.g., controller/processor 280 of FIG. 2). Further, the transmission and reception of signals by the UE in operations 1200 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1200 begin, at block 1210, by the UE receiving DCI (e.g. DCI 804) for scheduling SL communication for a first RAT (e.g., NR), the DCI including a CIF indicating a carrier of a second RAT (e.g., LTE) for the SL communication, where the SL communication is between the first UE and a second UE. At block 1220, the first UE communicates with the second UE based on the DCI. In some aspects, the first RAT may be associated with a first waveform, the second RAT may be associated with a second waveform that is different than the first waveform. In some aspects, the DCI schedules the SL communication using the first waveform associated with the first RAT. In other aspects, the DCI schedules the SL communication using the second waveform associated with the second RAT.

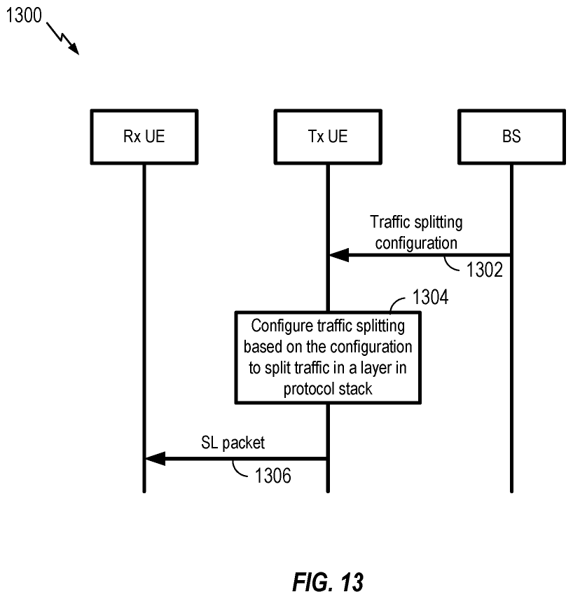

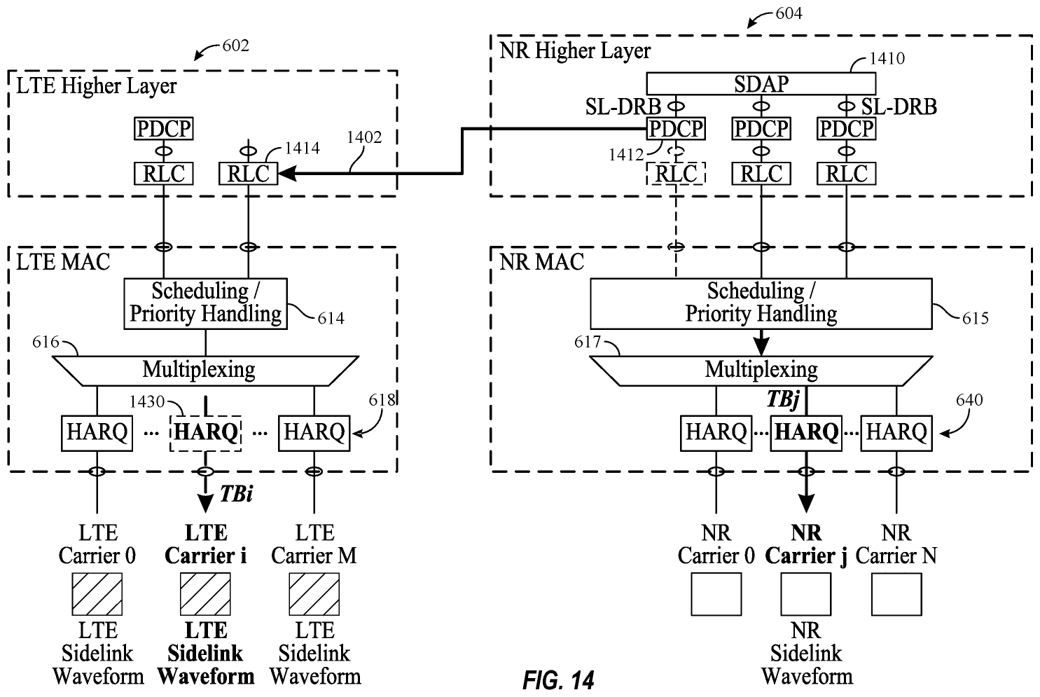

FIG. 13 is a call flow diagram illustrating example operations 1300 for configuration traffic splitting for SL, in accordance with certain aspects of the present disclosure. As shown, the BS may provide a traffic splitting configuration 1302 to a Tx UE. In some cases, the traffic splitting configuration 1302 indicates a layer for traffic splitting between a first protocol stack (e.g., a NR protocol stack) of the Tx UE and a second protocol stack (e.g., a LTE protocol stack) of the Tx UE. The traffic splitting facilitates the transmission of a SL packet for NR using a carrier for LTE. As illustrated, the Tx UE, at block 1304, configures traffic splitting based on the traffic splitting configuration 1302 received from the BS 102. Accordingly, the Tx UE 104 transmits a SL packet 1306 to the Rx UE using the traffic splitting configured at the Tx UE 104. Various example traffic splitting configurations for SL communication are described with respect to FIGS. 14-16.

FIGS. 14-16 are block diagrams illustrating example techniques for traffic splitting, in accordance with certain aspects of the present disclosure. As shown, the NR protocol stack 604 may include SL data radio bearers (SL-DRBs) between a service data adaptation protocol (SDAP) layer 1410 and PDCP layers. As shown in FIG. 14, traffic splitting may occur at the PDCP layer. For example, PDCP layer 1412 of the NR protocol stack 604 may provide a PDCP PDU 1402 to a radio link control (RLC) layer 1414 of the LTE protocol stack 602. Based on the PDCP PDU 1402, the RLC layer 1414 may generate a RLC PDU which may be provided to the scheduling/priority handling component 614. The scheduling/priority handling component 614 may provide the SL RLC PDU to multiplexer 616. The multiplexer 616 may then generate an LTE MAC PDU and provide the LTE MAC PDU to the HARQ component 1430 to generate TBi for transmission on LTE carrier i. In certain aspects, a NR SL-DRB may be used to perform the PDCP split, as described since a SL signaling radio bearer (SRB) may only be sent in a NR carrier.

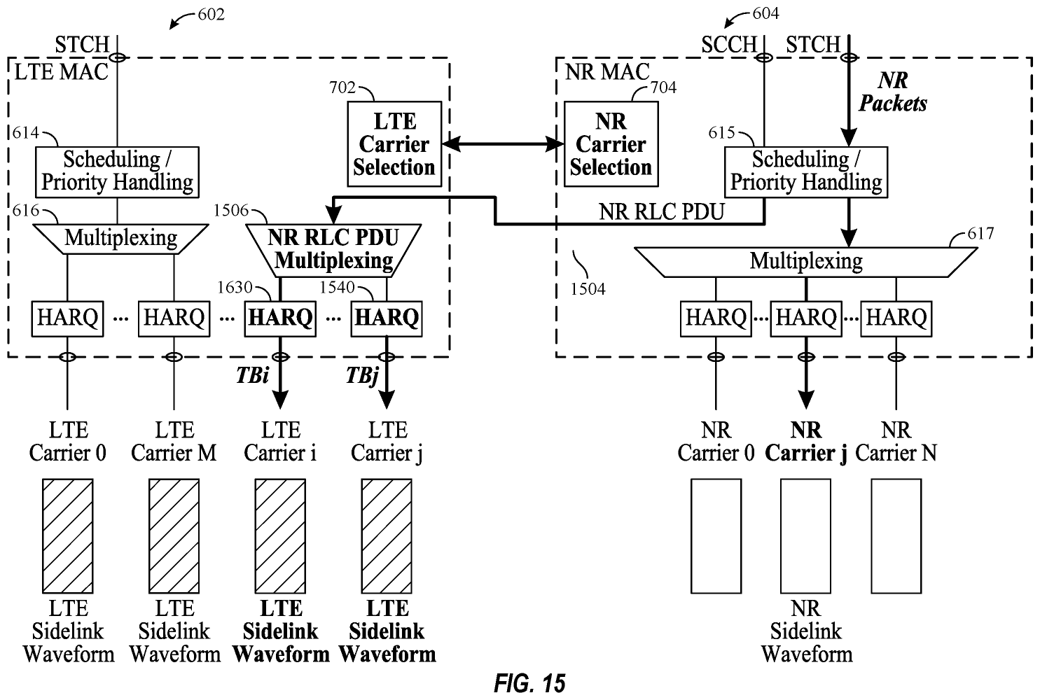

As shown in FIG. 15, traffic splitting may occur in the NR lower MAC layer. LTE carrier selection results may be exchanged with NR. For example, the LTE carrier selection component 702 of the LTE protocol stack 602 may indicate to the NR carrier selection component 704 of the NR protocol stack 604 that LTE carriers i and j are unoccupied. Some aspects provide enhanced NR logical channel prioritization (LCP) restriction for NR sidelink transmissions in LTE carriers. For example, only STCH with low priority may be multiplexed in TBi transmitted over the LTE carrier since multiplexing an STCH on TBi over the LTE carrier may be less reliable than using an NR carrier. The scheduling/priority handling component 615 may provide an NR RLC PDU 1504 to a NR RLC PDU multiplexing component 1506. The multiplexing component 1506 may generate LTE MAC PDUs provided to be HARQ components 1430, 1540. TBi and TBj may be generated by HARQ components 1430, 1540 and transmitted using CA on LTE carriers i and j using LTE waveforms, as shown.

As shown in FIG. 16, traffic splitting may occur in the NR lower MAC layer. LTE carrier selection results may be exchanged with NR. For example, the LTE carrier selection component 702 of the LTE protocol stack 602 may indicate to the NR carrier selection component 704 of the NR protocol stack 604 that LTE carrier i is unoccupied. As shown, one or more NR RLC PDUs 1602 to be transmitted on the unoccupied LTE carrier(s) may be sent to the LTE MAC layer to perform scheduling/LCP via the scheduling/priority handling component 614. The LTE carrier selection component 702 may indicate, to the scheduling/priority handling component 614, the unoccupied carriers to be used, allowing the scheduling/priority handling component 614 to schedule the NR SL transmission accordingly. For instance, NR RLC PDU(s) generated by scheduling/priority handling component 614 may be sent to the multiplexer 616, and an LTE MAC PDU may be generated. LTE TBi is then generated and handled by the LTE HARQ component (e.g., HARQ component 1430) for transmission on LTE carrier i using the LTE waveform. Certain aspects provide enhancements to LTE LCP restriction for NR sidelink transmissions in LTE carriers. For example, specific LTE carrier(s) may be restricted for NR sidelink transmission.

FIG. 17 is a flow diagram illustrating example operations 1700 for wireless communication, in accordance with certain aspects of the present disclosure. The operations 1700 may be performed, for example, by a UE (e.g., the UE 120a in the wireless communication network 100). The operations 1700 may be implemented as software components that are executed and run on one or more processors (e.g., controller/processor 280 of FIG. 2). Further, the transmission and reception of signals by the UE in operations 1700 may be enabled, for example, by one or more antennas (e.g., antennas 252 of FIG. 2). In certain aspects, the UE's transmission and/or reception of signals may be implemented via a bus interface of one or more processors (e.g., controller/processor 280) obtaining and/or outputting signals.

The operations 1700 begin, at block 1710, with the UE receiving, from a BS, a configuration (e.g., configuration 1302) for SL traffic splitting between a first protocol stack of the UE and a second protocol stack of the UE, where the first protocol stack (e.g., protocol stack 604) is for a first RAT and the second protocol stack (e.g., protocol stack 602) is for a second RAT, the first RAT being different than the second RAT. In some aspects, the configuration may indicate a layer (e.g., the RLC layer or MAC layer) of the first protocol stack and the second protocol stack to be used for the traffic splitting. At block 1720, the UE communicates, via the second protocol stack, at least one TB for SL communication in accordance with the configuration.

FIG. 18 is a flow diagram illustrating example operations 1800 for wireless communication, in accordance with certain aspects of the present disclosure. The operations 1800 may be performed, for example, by a network entity and/or a BS (e.g., the BS 110a in the wireless communication network 100). The operations 1800 may be complementary to the operations 1700 performed by the UE. The operations 1800 may be implemented as software components that are executed and run on one or more processors (e.g., controller/processor 240 of FIG. 2). Further, the transmission and reception of signals by the BS in operations 1800 may be enabled, for example, by one or more antennas (e.g., antennas 234 of FIG. 2). In certain aspects, the BS's transmission and/or reception of signals may be implemented via a bus interface of one or more processors (e.g., controller/processor 240) obtaining and/or outputting signals.

The operations 1800 begin, at block 1810, with the BS generating a message indicating a configuration (e.g., configuration 1302) for SL traffic splitting between a first protocol stack (e.g., protocol stack 604) of a UE and a second protocol stack (e.g., protocol stack 602) of the UE, where the first protocol stack is for a first RAT and the second protocol stack is for a second RAT, the first RAT being different than the second RAT. In some aspects, the configuration may indicate a layer of the first protocol stack and the second protocol stack to be used for the traffic splitting. At block 1820, the BS may transmit the message to the UE.

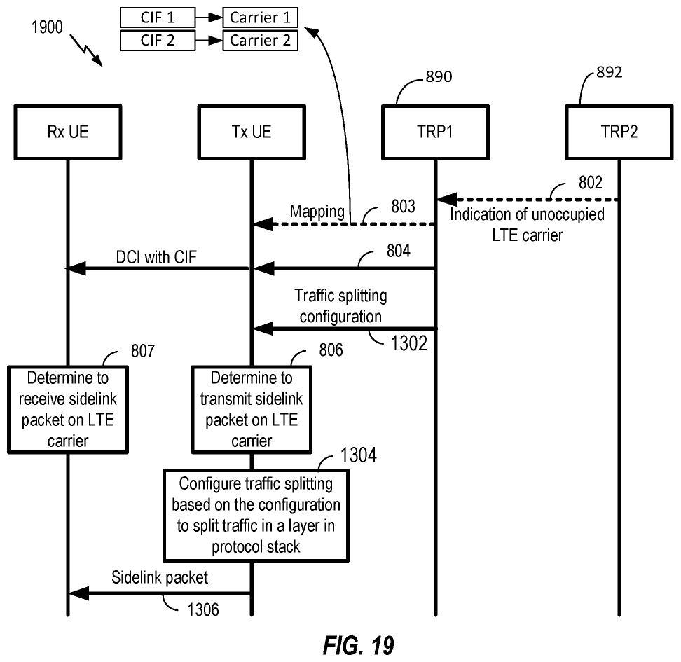

FIG. 19 is a call flow diagram illustrating example operations 1900 for configuring SL communication, in accordance with certain aspects of the present disclosure. TRP1 (e.g., an NR BS) may be implemented for a first RAT (e.g., a NR) and TRP2 (e.g., an LTE BS) may be implemented for a second RAT (e.g., LTE). The operations 1900 depicted in the call flow may be used to indicate to a receive (Rx) UE and a transmit (Tx) UE that one or more carriers are available in LTE to communicate a NR SL message/packet on a LTE carrier. As shown, TRP2 may optionally provide, to TRP1, an indication 802 of at least one unoccupied LTE carrier. TRP1 may indicate DCI 804 to each of the Rx UE and Tx UE, where the DCI indicates a CIF. The CIF may indicate at least one unoccupied LTE carrier to be used for SL communication between the Rx UE and the Tx UE. In some aspects, a mapping 803 may indicate the mapping between the CIF and the LTE carrier. At block 806, the Tx UE determines to transmit a SL packet on the unoccupied LTE carrier, and at block 807, the Rx UE determines to receive the SL packet on the unoccupied LTE carrier.

In some aspects, the TRP1 may also provide a traffic splitting configuration 1302 to the Tx UE. In some cases, the traffic splitting configuration 1302 indicates a layer for traffic splitting between a first protocol stack (e.g., a NR protocol stack) of the Tx UE and a second protocol stack (e.g., a LTE protocol stack) of the Tx UE. Various example traffic splitting configurations for SL communication are described with respect to FIGS. 14-16. The traffic splitting facilitates the transmission of a SL packet for NR using a carrier for LTE. As illustrated, the Tx UE, at block 1304, configures traffic splitting based on the traffic splitting configuration 1302 received from the BS 102. Accordingly, the Tx UE 104 transmits a SL packet 1306 to the Rx UE using the traffic splitting configured at the Tx UE 104.

### Example Wireless Communication Devices

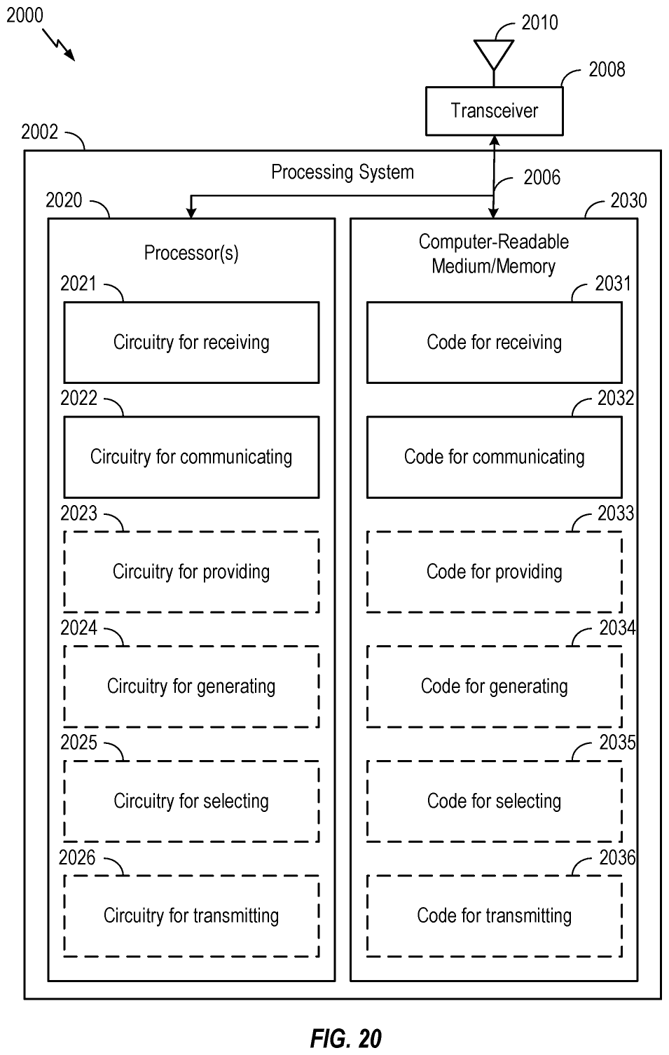

FIG. 20 depicts an example communications device 2000 that includes various components operable, configured, or adapted to perform operations for the techniques disclosed herein, such as the operations depicted and described with respect to FIGS. 8-18. In some examples, communication device 2000 may be a user equipment 104 as described, for example with respect to FIGS. 1 and 2.

Communications device 2000 includes a processing system 2002 coupled to a transceiver 2008 (e.g., a transmitter and/or a receiver). Transceiver 2008 is configured to transmit (or send) and receive signals for the communications device 2000 via an antenna 2010, such as the various signals as described herein. Processing system 2002 may be configured to perform processing functions for communications device 2000, including processing signals received and/or to be transmitted by communications device 2000.

Processing system 2002 includes one or more processors 2020 coupled to a computer-readable medium/memory 2030 via a bus 2006. In certain aspects, computer-readable medium/memory 2030 is configured to store instructions (e.g., computer-executable code) that when executed by the one or more processors 2020, cause the one or more processors 2020 to perform the operations illustrated in FIGS. 8-18, or other operations for performing the various techniques discussed herein for coordination of carrier selection between long term evolution (LTE) and new radio (NR) sidelink (SL).

In the depicted example, computer-readable medium/memory 2030 stores code 2031 (e.g., an example of means for) for receiving; code 2032 (e.g., an example of means for) for communicating. The computer-readable medium/memory 2030 may optionally also include code 2033 (e.g., an example of means for) for providing; code 2034 (e.g., an example of means for) for generating; code 2035 (e.g., an example of means for) for selecting; and code 2036 (e.g., an example of means for) for transmitting.

In the depicted example, the one or more processors 2020 include circuitry configured to implement the code stored in the computer-readable medium/memory 2030, including circuitry 2021 (e.g., an example of means for) for receiving; circuitry 2022 (e.g., an example of means for) for communicating. The one or more processors 2020 may optionally also include circuitry 2023 (e.g., an example of means for) for providing; circuitry 2024 (e.g., an example of means for) for generating; circuitry 2025 (e.g., an example of means for) for selecting; and circuitry 2026 (e.g., an example of means for) for transmitting

Various components of communications device 2000 may provide means for performing the methods described herein, including with respect to FIGS. 8-18.

In some examples, means for transmitting or sending (or means for outputting for transmission) may include the transceivers 254 and/or antenna(s) 252 of the user equipment 104 illustrated in FIG. 2 and/or transceiver 2008 and antenna 2010 of the communication device 2000 in FIG. 20.

In some examples, means for receiving (or means for obtaining) may include the transceivers 254 and/or antenna(s) 252 of the user equipment 104 illustrated in FIG. 2 and/or transceiver 2008 and antenna 2010 of the communication device 2000 in FIG. 20.

In some examples, means for providing, means for generating, and/or means for selecting may include various processing system components, such as: the one or more processors 2020 in FIG. 20, or aspects of the user equipment 104 depicted in FIG. 2, including receive processor 258, transmit processor 264, TX MIMO processor 266, and/or controller/processor 280 (including SL component 281).

Notably, FIG. 20 is just use example, and many other examples and configurations of communication device 2000 are possible.

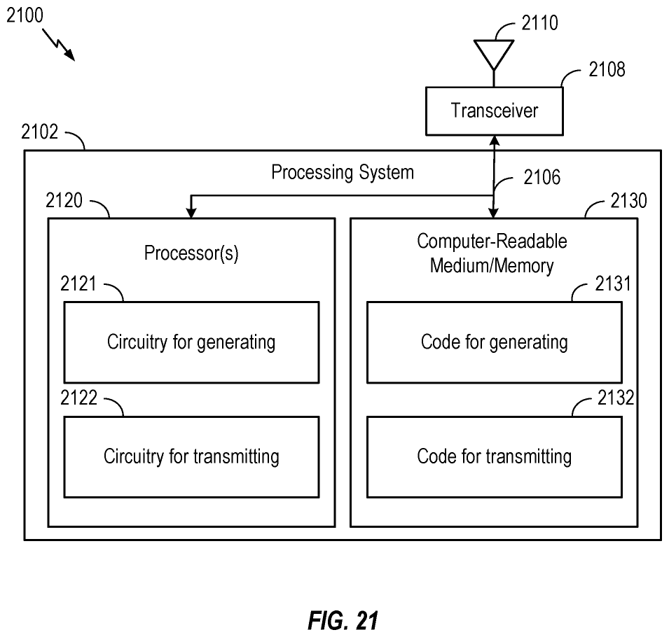

FIG. 21 depicts an example communications device 2100 that includes various components operable, configured, or adapted to perform operations for the techniques disclosed herein, such as the operations depicted and described with respect to FIGS. 8-18. In some examples, communication device 2100 may be a base station 102 as described, for example with respect to FIGS. 1 and 2.

Communications device 2100 includes a processing system 2102 coupled to a transceiver 2108 (e.g., a transmitter and/or a receiver). Transceiver 2108 is configured to transmit (or send) and receive signals for the communications device 2100 via an antenna 2110, such as the various signals as described herein. Processing system 2102 may be configured to perform processing functions for communications device 2100, including processing signals received and/or to be transmitted by communications device 2100.

Processing system 2102 includes one or more processors 2120 coupled to a computer-readable medium/memory 2130 via a bus 2106. In certain aspects, computer-readable medium/memory 2130 is configured to store instructions (e.g., computer-executable code) that when executed by the one or more processors 2120, cause the one or more processors 2120 to perform the operations illustrated in FIGS. 8-18, or other operations for performing the various techniques discussed herein for coordination of carrier selection between LTE and NR SL.

In the depicted example, computer-readable medium/memory 2130 stores code 2131 (e.g., an example of means for) for generating; and code 2132 (e.g., an example of means for) for transmitting.

In the depicted example, the one or more processors 2120 include circuitry configured to implement the code stored in the computer-readable medium/memory 2130, including circuitry 2121 for generating; and circuitry 2122 for transmitting.

Various components of communications device 2100 may provide means for performing the methods described herein, including with respect to FIGS. 8-18.

In some examples, means for transmitting or sending (or means for outputting for transmission) may include the transceivers 232 and/or antenna(s) 234 of the base station 102 illustrated in FIG. 2 and/or transceiver 2108 and antenna 2110 of the communication device 2100 in FIG. 21.

In some examples, means for receiving (or means for obtaining) may include the transceivers 232 and/or antenna(s) 234 of the base station illustrated in FIG. 2 and/or transceiver 2108 and antenna 2110 of the communication device 2100 in FIG. 21.

In some examples, means for generating may include various processing system components, such as: the one or more processors 2120 in FIG. 21, or aspects of the base station 102 depicted in FIG. 2, including receive processor 238, transmit processor 220, TX MIMO processor 230, and/or controller/processor 240 (including carrier indication component 241).

Notably, FIG. 21 is just use example, and many other examples and configurations of communication device 2100 are possible.

The transceiver 2008 or 2108 may provide a means for receiving or transmitting information such as packets, user data, or control information associated with various information channels (e.g., control channels, data channels, and information related to feedback, etc.). Information may be passed on to other components of the device 2000 or 2100. The transceiver 2008 or 2108 may be an example of aspects of the transceiver 254 described with reference to FIG. 2. The antenna 2010 or 2110 may correspond to a single antenna or a set of antennas. The transceiver 2008 or 2108 may provide means for transmitting signals generated by other components of the device 2000 or 2100.

The SL component 197, 198 or 199 may support wireless communication in accordance with examples as disclosed herein.

The SL component 197, 198 or 199 may be an example of means for performing various aspects described herein. The SL component 197, 198 or 199, or its sub-components, may be implemented in hardware (e.g., in uplink resource management circuitry). The circuitry may comprise of processor, DSP, an ASIC, a FPGA or other programmable logic device, discrete gate or transistor logic, discrete hardware components, or any combination thereof designed to perform the functions described in the present disclosure.

In another implementation, the SL component 197, 198 or 199, or its sub-components, may be implemented in code (e.g., as configuration management software or firmware) executed by a processor, or any combination thereof. If implemented in code executed by a processor, the functions of the SL component 197, 198 or 199, or its sub-components may be executed by a general-purpose processor, a DSP, an ASIC, a FPGA or other programmable logic device.

In some examples, the SL component 197, 198 or 199 may be configured to perform various operations (e.g., receiving, determining, transmitting) using or otherwise in cooperation with the transceiver 2008, 2108.

The SL component 197, 198 or 199, or its sub-components, may be physically located at various positions, including being distributed such that portions of functions are implemented at different physical locations by one or more physical components. In some examples, the SL component 197, 198 or 199, or its sub-components, may be a separate and distinct component in accordance with various aspects of the present disclosure. In some examples, the SL component 197, 198 or 199, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

### Example Clauses

Implementation examples are described in the following numbered clauses:

Clause 1. A method for wireless communication by a base station (BS), comprising: generating downlink control information (DCI) for scheduling sidelink (SL) communication for a first radio access technology (RAT), the DCI including a carrier indication field (CIF) indicating a carrier of a second RAT for the SL communication, wherein the SL communication is between a first user-equipment (UE) and a second UE; and transmitting the DCI to at least one of the first UE or the second UE.

Clause 2. The method of clause 1, wherein the first RAT is associated with a first waveform, wherein the second RAT is associated with a second waveform that is different than the first waveform, and wherein the DCI schedules the SL communication using the first waveform associated with the first RAT.

Clause 3. The method of any one of clauses 1-2, wherein the first RAT is associated with a first waveform, wherein the second RAT is associated with a second waveform that is different than the first waveform, and wherein the DCI schedules the SL communication using the second waveform associated with the second RAT.

Clause 4. The method of any one of clauses 1-3, further comprising transmitting a message indicating a mapping between candidate CIFs and candidate carriers designated for the second RAT, wherein the CIF is one of the candidate CIFs, and wherein the carrier of the second RAT is one of the candidate carriers.

Clause 5. The method of clause 4, wherein the message comprises a radio resource control (RRC) message.

Clause 6. The method of any one of clauses 1-5, wherein the DCI is transmitted by a first transmission reception point (TRP) of the BS, the method further comprising receiving, from a second TRP, an indication that the carrier of the second RAT is unoccupied, wherein the DCI is generated based on the indication.

Clause 7. The method of clause 6, wherein the first TRP and the second TRP are co-located.

Clause 8. The method of any one of clauses 6-7, wherein the indication is received from the second TRP via an X2 interface.

Clause 9. The method of clause 1, wherein the first RAT comprises new-radio (NR), and wherein the second RAT comprises long-term evolution (LTE).

Clause 10. A method for wireless communication by a first user-equipment (UE), comprising: receiving downlink control information (DCI) for scheduling sidelink (SL) communication for a first radio access technology (RAT), the DCI including a carrier indication field (CIF) indicating a carrier of a second RAT for the SL communication, wherein the SL communication is between the first UE and a second UE; and communicating with the second UE based on the DCI.

Clause 11. The method of clause 10, wherein the first RAT is associated with a first waveform, wherein the second RAT is associated with a second waveform that is different than the first waveform, and wherein the DCI schedules the SL communication using the first waveform associated with the first RAT.

Clause 12. The method of any one of clauses 10-11, wherein the first RAT is associated with a first waveform, wherein the second RAT is associated with a second waveform that is different than the first waveform, and wherein the DCI schedules the SL communication using the second waveform associated with the second RAT.

Clause 13. The method of any one of clauses 10-12, further comprising receiving a message indicating a mapping between candidate CIFs and candidate carriers designated for the second RAT, wherein the CIF is one of the candidate CIFs, and wherein the carrier of the second RAT is one of the candidate carriers.

Clause 14. The method of clause 13, wherein the message comprises a radio resource control (RRC) message.

Clause 15. The method of any one of clauses 10-14, wherein the first RAT comprises new-radio (NR), and wherein the second RAT comprises long-term evolution (LTE).

Clause 16. A method for wireless communication by a user-equipment (UE), comprising: receiving, from a base station (BS), a configuration for sidelink (SL) traffic splitting between a first protocol stack of the UE and a second protocol stack of the UE, wherein the first protocol stack is for a first radio access technology (RAT) and the second protocol stack is for a second RAT, the first RAT being different than the second RAT, and wherein the configuration indicates a layer of the first protocol stack and the second protocol stack to be used for the traffic splitting; and communicating, via the second protocol stack, at least one transport block (TB) for SL communication in accordance with the configuration.

Clause 17. The method of clause 16, wherein the layer comprises a packet data convergence protocol (PDCP) layer.

Clause 18. The method of any one of clauses 16-17, wherein the layer comprises a medium access control (MAC) layer.

Clause 19. The method of clause 18, wherein communicating the at least one TB in accordance with the configuration comprises: providing a radio link control (RLC) protocol data unit (PDU) for the first RAT from a scheduling component of the MAC layer for the first protocol stack to a multiplexing component of the MAC layer for the second protocol stack; generating, via the multiplexing component, a MAC PDU for the second RAT based on the RLC PDU; and generating the at least one TB for the SL communication via a hybrid automatic repeat request (HARQ) component for the second protocol stack.

Clause 20. The method of any one of clauses 18-19, wherein communicating the at least one TB in accordance with the configuration comprises: providing a radio link control (RLC) protocol data unit (PDU) for the first RAT from the MAC layer for the first protocol stack to a scheduling component of the MAC layer for the second protocol stack; selecting, via the scheduling component, a carrier of the second RAT for the SL communication; and generating the at least one TB for the communication on the carrier via a hybrid automatic repeat request (HARQ) component for the second protocol stack.

Clause 21. The method of any one of clauses 16-20, further comprising selecting a sidelink traffic channel (STCH) of the first protocol stack for the SL traffic splitting based on a priority associated with STCH.

Clause 22. The method of any one of clauses 16-21, further comprising: selecting a carrier of the second RAT to be used for the SL communication; and transmitting, to the BS, an indication of the selected carrier.

Clause 23. A method for wireless communication by a base station, comprising: generating a message indicating a configuration for sidelink (SL) traffic splitting between a first protocol stack of a user-equipment (UE) and a second protocol stack of the UE, wherein the first protocol stack is for a first radio access technology (RAT) and the second protocol stack is for a second RAT, the first RAT being different than the second RAT, and wherein the configuration indicates a layer of the first protocol stack and the second protocol stack to be used for the traffic splitting; and transmitting the message to the UE.

Clause 24. The method of clause 23, wherein the layer comprises a packet data convergence protocol (PDCP) layer.

Clause 25. The method of any one of clauses 23-24, wherein the layer comprises a medium access control (MAC) layer.

Clause 26. The method of any one of clauses 23-25, further comprising selecting a sidelink traffic channel (STCH) of the first protocol stack for the SL traffic splitting based on a priority associated with STCH.

Clause 27. The method of any one of clauses 23-26, further comprising: receiving, from the UE, an indication of a carrier of the second RAT to be used for SL communication; and performing carrier selection for SL scheduling for one or more other UEs based on the carrier.

Clause 28: An apparatus, comprising: a memory and one or more processors coupled to the memory, the memory and the one or more processors being configured to perform a method in accordance with any one of Clauses 1-27.

Clause 29: An apparatus, comprising means for performing a method in accordance with any one of Clauses 1-27.

Clause 30: A non-transitory computer-readable medium comprising executable instructions that, when executed by one or more processors of an apparatus, cause the apparatus to perform a method in accordance with any one of Clauses 1-27.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS or a home BS.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with core network 190 through second backhaul links 184. Base stations 102 may communicate directly or indirectly (e.g., through the EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station. The gNB 180 may also communicate with one or more UEs 104 via a beam formed connection 182 (e.g., via beams 182′ and 182″).

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs (e.g., UE 104 and UE 105) may communicate with each other using device-to-device (D2D) communication link 158 (also referred to as a sidelink (SL)). The D2D communication link 158 may use the DL/UL WWAN spectrum. The D2D communication link 158 may use one or more SL channels, such as a physical SL broadcast channel (PSBCH), a physical SL discovery channel (PSDCH), a physical SL shared channel (PSSCH), and a physical SL control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of NR and LTE sidelink co-channel co-existence in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication by a base station (BS), comprising:
a memory; and
one or more processors coupled to the memory, the memory and the one or more processors being configured to:
generate downlink control information (DCI) for scheduling sidelink (SL) communication for a first radio access technology (RAT), the DCI including a carrier indication field (CIF) indicating a carrier of a second RAT for the SL communication, wherein the SL communication is between a first user-equipment (UE) and a second UE, the first RAT being different than the second RAT; and
transmit the DCI to at least one of the first UE or the second UE.

2. The apparatus of claim 1, wherein the first RAT is associated with a first waveform, wherein the second RAT is associated with a second waveform that is different than the first waveform, and wherein the DCI schedules the SL communication using the first waveform associated with the first RAT.

3. The apparatus of claim 1, wherein the first RAT is associated with a first waveform, wherein the second RAT is associated with a second waveform that is different than the first waveform, and wherein the DCI schedules the SL communication using the second waveform associated with the second RAT.

4. The apparatus of claim 1, wherein the memory and the one or more processors are further configured to transmit a message indicating a mapping between candidate CIFs and candidate carriers designated for the second RAT, wherein the CIF is one of the candidate CIFs, and wherein the carrier of the second RAT is one of the candidate carriers.

5. The apparatus of claim 4, wherein the message comprises a radio resource control (RRC) message.

6. The apparatus of claim 1, wherein the memory and the one or more processors are configured to transmit the DCI by a first transmission reception point (TRP) of the BS, the memory and the one or more processors being further configured to receive, from a second TRP, an indication that the carrier of the second RAT is unoccupied, wherein the DCI is generated based on the indication.

7. The apparatus of claim 6, wherein the first TRP and the second TRP are co-located.

8. The apparatus of claim 6, wherein the memory and the one or more processors are configured to receive the indication from the second TRP via an X2 interface.

9. The apparatus of claim 1, wherein the first RAT comprises new-radio (NR), and wherein the second RAT comprises long-term evolution (LTE).

10. An apparatus for wireless communication by a first user-equipment (UE), comprising:
a memory; and
one or more processors coupled to the memory, the memory and the one or more processors being configured to:
receive downlink control information (DCI) for scheduling sidelink (SL) communication for a first radio access technology (RAT), the DCI including a carrier indication field (CIF) indicating a carrier of a second RAT for the SL communication, wherein the SL communication is between the first UE and a second UE; and
communicate with the second UE based on the DCI.

11. The apparatus of claim 10, wherein the first RAT is associated with a first waveform, wherein the second RAT is associated with a second waveform that is different than the first waveform, and wherein the DCI schedules the SL communication using the first waveform associated with the first RAT.

12. The apparatus of claim 10, wherein the first RAT is associated with a first waveform, wherein the second RAT is associated with a second waveform that is different than the first waveform, and wherein the DCI schedules the SL communication using the second waveform associated with the second RAT.

13. The apparatus of claim 10, wherein the memory and the one or more processors are further configured to receive a message indicating a mapping between candidate CIFs and candidate carriers designated for the second RAT, wherein the CIF is one of the candidate CIFs, and wherein the carrier of the second RAT is one of the candidate carriers.

14. The apparatus of claim 13, wherein the message comprises a radio resource control (RRC) message.

15. The apparatus of claim 10, wherein the first RAT comprises new-radio (NR), and wherein the second RAT comprises long-term evolution (LTE).

16. An apparatus for wireless communication by a user-equipment (UE), comprising:
a memory; and
one or more processors coupled to the memory, the memory and the one or more processors being configured to:
receive, from a base station (BS), a configuration for sidelink (SL) traffic splitting between a first protocol stack of the UE and a second protocol stack of the UE, wherein the first protocol stack is for a first radio access technology (RAT) and the second protocol stack is for a second RAT, the first RAT being different than the second RAT, and wherein the configuration indicates a layer of the first protocol stack and the second protocol stack to be used for the traffic splitting; and
communicate, via the second protocol stack, at least one transport block (TB) for SL communication in accordance with the configuration.

17. The apparatus of claim 16, wherein the layer comprises a packet data convergence protocol (PDCP) layer.

18. The apparatus of claim 16, wherein the layer comprises a medium access control (MAC) layer.

19. The apparatus of claim 18, wherein in communicating the at least one TB in accordance with the configuration, the memory and the one or more processors are configured to:
provide a radio link control (RLC) protocol data unit (PDU) for the first RAT from a scheduling component of the MAC layer for the first protocol stack to a multiplexing component of the MAC layer for the second protocol stack;
generate, via the multiplexing component, a MAC PDU for the second RAT based on the RLC PDU; and
generate the at least one TB for the SL communication via a hybrid automatic repeat request (HARQ) component for the second protocol stack.

20. The apparatus of claim 18, wherein in communicating the at least one TB in accordance with the configuration, the memory and the one or more processors are configured to:
provide a radio link control (RLC) protocol data unit (PDU) for the first RAT from the MAC layer for the first protocol stack to a scheduling component of the MAC layer for the second protocol stack;
select, via the scheduling component, a carrier of the second RAT for the SL communication; and
generate the at least one TB for the communication on the carrier via a hybrid automatic repeat request (HARQ) component for the second protocol stack.

21. The apparatus of claim 16, wherein the memory and the one or more processors are further configured to select a sidelink traffic channel (STCH) of the first protocol stack for the SL traffic splitting based on a priority associated with STCH.

22. The apparatus of claim 16, wherein the memory and the one or more processors are further configured to:
select a carrier of the second RAT to be used for the SL communication; and
transmit, to the BS, an indication of the selected carrier.

23. An apparatus for wireless communication by a base station, comprising:
a memory; and
one or more processors coupled to the memory, the memory and the one or more processors being configured to:
generate a message indicating a configuration for sidelink (SL) traffic splitting between a first protocol stack of a user-equipment (UE) and a second protocol stack of the UE, wherein the first protocol stack is for a first radio access technology (RAT) and the second protocol stack is for a second RAT, the first RAT being different than the second RAT, and wherein the configuration indicates a layer of the first protocol stack and the second protocol stack to be used for the traffic splitting; and
transmit the message to the UE.

24. The apparatus of claim 23, wherein the layer comprises a packet data convergence protocol (PDCP) layer.

25. The apparatus of claim 23, wherein the layer comprises a medium access control (MAC) layer.

26. The apparatus of claim 23, wherein the memory and the one or more processors are further configured to select a sidelink traffic channel (STCH) of the first protocol stack for the SL traffic splitting based on a priority associated with STCH.

27. The apparatus of claim 23, wherein the memory and the one or more processors are further configured to:
receive, from the UE, an indication of a carrier of the second RAT to be used for SL communication; and
perform carrier selection for SL scheduling for one or more other UEs based on the carrier.
